(19) United States
(12) Patent Application Publication
(10) Pub. No.: US 2026/0145334 A1
(43) Pub. Date: May 28, 2026

(54) ROBOT OPERATION APPARATUS AND METHOD IN MULTI-CLUSTER-BASED CLOUD ENVIRONMENT

(71) Applicant: ELECTRONICS AND TELECOMMUNICATIONS RESEARCH INSTITUTE, Daejeon (KR)

(72) Inventors: Dae-Won KIM, Daejeon (KR); Su-Min JANG, Sejong-si (KR)

(73) Assignee: ELECTRONICS AND TELECOMMUNICATIONS RESEARCH INSTITUTE, Daejeon (KR)

(21) Appl. No.: 19/400,693

(22) Filed: Nov. 25, 2025

(30) Foreign Application Priority Data
Nov. 28, 2024 (KR) 10-2024-0173431
Oct. 17, 2025 (KR) 10-2025-0150212

(51) Int. Cl. B25J 9/16; G06F 9/455

(52) U.S. Cl. CPC B25J 9/1682; B25J 9/1656; G06F 9/45558; G06F 2009/45595

(57) ABSTRACT

Disclosed herein are a robot operation apparatus and method in a multi-cluster-based cloud environment. The robot operation apparatus in a multi-cluster-based cloud environment is configured to set up a secure network connection between clusters using an Internet Protocol Security (IPsec) tunnel, establish a data synchronization policy between robots by configuring an in-memory-based shared storage, establish a data exchange policy between robots based on a preset framework, and perform a robot task through a container and a virtual machine that are deployed in the clusters.

### CROSS REFERENCE TO RELATED APPLICATIONS

This application claims the benefit of Korean Patent Application Nos. 10-2024-0173431, filed November 28, 2024 and 10-2025-0150212, filed October 17, 2025, which are hereby incorporated by reference in their entireties into this application.

### BACKGROUND OF THE INVENTION

### 1. Technical Field

The present disclosure relates to a technology for operating and managing distributed cloud and edge computing, and more particularly to a robot operation technology in a multi-cluster-based cloud environment.

### 2. Description of the Related Art

A module-based robot operation in a multi-cluster (e.g., Kubernetes)-based cloud environment is a method of maximizing flexibility and scalability by modularizing the functions of a robot and distributing and deploying the modularized functions across a cloud infrastructure. This approach is configured to separate individual functions of a robot, such as tasks such as sensor data processing, path planning, and control, into modules, thus enabling individual modules to be independently managed. These modules are separated and executed into a robot itself, a local cluster, and a central cluster, and each cluster performs tasks corresponding to the role thereof.

In the robot, functions such as sensor data processing and motor control, which require real-time responses, are performed. The local cluster is designed to process Light Detection and Ranging (LiDAR) data filtering, basic Simultaneous Localization and Mapping (SLAM) operations, and the like in an edge computing environment close to the robot, and continue to perform critical operations/tasks even in the case where network connectivity is unstable. The central cluster may process complex and computationally-intensive tasks such as high-resolution map generation or AI-based object recognition. Such a hierarchical structure helps distribute computational demands in a balanced manner between real-time and high-performance tasks.

Communication between the robot and a cluster and communication between clusters are performed through the Data Distribution Service (DDS) of Robot Operating System 2 (ROS2), while, within each cluster, data is exchanged with low delay using a multicast or unicast method. Generally, communication between clusters is stably maintained through a network connection tool such as Submariner, VPN, or NFS. Kubernetes plays a key role in automating module deployment, optimizing cluster resources, and providing scalability. By utilizing node affinity and autoscaling functions, low-latency tasks are optimally deployed in the local cluster, and high-performance tasks are optimally deployed in the central cluster.

In a multi-cluster-based cloud environment, module-based robot operation may modularize the functions of the robot, thus providing the advantages of improving the flexibility of the entire system and easily adding or modifying functions if necessary. Further, the hardware burden on the robot itself may be reduced, and high-performance resources of the cloud may be utilized, with the result that cost efficiency is improved. However, disadvantages such as network dependency and operation complexity may be present. In order to overcome the disadvantages, there are required strategies for providing against network problems by utilizing the local cluster or for reducing operational complexity by utilizing an automation function of Kubernetes.

The module-based robot operation in a multi-cluster-based cloud environment provides optimal performance by effectively combining real-time processing of the robot, stable task processing of the local cluster, and high-performance computing of the central cluster. By means of this, a robot system may also efficiently process complex tasks while maintaining high scalability and flexibility.

Meanwhile, U.S. Patent No. 11,252,159 entitled “Cognitive access control policy management in a multi-cluster container orchestration environment” discloses a method for dynamically applying access control policies unique to each user in a multi-cluster container orchestration environment.

### SUMMARY OF THE INVENTION

Accordingly, the present disclosure has been made keeping in mind the above problems occurring in the prior art, and an object of the present disclosure is to provide a method for managing a modularized robot in single-cluster and multi-cluster environments.

Another object of the present disclosure is to ensure the operation of a high-performance robot module by utilizing resources integrated with virtual machines in a container environment of existing Kubernetes (K8S).

A further object of the present disclosure is to generate a high-speed storage for efficient data exchange between clusters.

Yet another object of the present disclosure is to improve the speed of a shared storage through high-speed network connection between clusters.

Still another object of the present disclosure is to solve memory constraints and ensure easy use with an integrated kernel.

Still another object of the present disclosure is to construct a high-speed network that enables the connection of a multi-cluster network to be performed at high speed.

Still another object of the present disclosure is to share various types of application data between clusters, without transmitting the data, through a shared storage function based on a high-performance computing environment.

Still another object of the present disclosure is to provide a system usable when access to different domains is impossible through an existing DDS, and ensure real-time performance, data persistence, etc. through a high-speed memory-based shared storage.

In accordance with an aspect of the present disclosure to accomplish the above objects, there is provided a robot operation apparatus in a multi-cluster-based cloud environment, including one or more processors, and a memory configured to store at least one program that is executed by the one or more processors, wherein the at least one program is configured to set up a secure network connection between clusters using an Internet Protocol Security (IPsec) tunnel, establish a data synchronization policy between robots by configuring an in-memory-based shared storage, establish a data exchange policy between robots based on a preset framework, and perform a robot task through a container and a virtual machine that are deployed in the clusters.

Here, the at least one program may be configured to construct the in-memory-based shared storage by connecting a global repository to local repositories of multiple clusters.

Here, the at least one program may be configured to set storage access priority for the in-memory-based shared storage based on a predefined QoS policy.

Here, the at least one program may be configured to preferentially store data generated during real-time processing of the robot task in the local repository, and set data required for collaboration between the clusters to be synchronized with the global repository.

Here, the at least one program may be configured such that each robot transmits data through a topic based on a publisher/subscriber structure of a preset Robot Operating System 2 (ROS2) framework.

Here, the at least one program may be configured to provide a common Application Programming Interface (API) configured to simultaneously run the virtual machine and the container.

Here, the at least one program may be configured such that a container deployed in a local cluster, among the clusters, performs an action task of the robot.

Here, the at least one program may be configured such that a virtual machine deployed in a cluster of a data center, among the clusters, performs a computing task of the robot.

In accordance with another aspect of the present disclosure to accomplish the above objects, there is provided a robot operation method in a multi-cluster-based cloud environment, performed by a robot operation apparatus in a multi-cluster-based cloud environment, the robot operation method including setting up a secure network connection between clusters using an Internet Protocol Security (IPsec) tunnel; establishing a data synchronization policy between robots by configuring an in-memory-based shared storage; establishing a data exchange policy between robots based on a preset framework; and performing a robot task through a container and a virtual machine that are deployed in the clusters.

Here, establishing the data synchronization policy may include constructing the in-memory-based shared storage by connecting a global repository to local repositories of multiple clusters.

Here, establishing the data synchronization policy may further include setting storage access priority for the in-memory-based shared storage based on a predefined QoS policy.

Here, establishing the data synchronization policy may further include preferentially storing data generated during real-time processing of the robot task in the local repository, and setting data required for collaboration between the clusters to be synchronized with the global repository.

Here, establishing the data exchange policy may include allowing each robot to transmit data through a topic based on a publisher/subscriber structure of a preset Robot Operating System 2 (ROS2) framework.

Here, performing the robot task may include providing a common Application Programming Interface (API) configured to simultaneously run the virtual machine and the container.

Here, performing the robot task may include allowing a container deployed in a local cluster, among the clusters, to perform an action task of the robot.

Here, performing the robot task may include allowing a virtual machine deployed in a cluster of a data center, among the clusters, to perform a computing task of the robot

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a system for operating cloud-based multi-cluster edge computing according to an embodiment of the present disclosure;

FIG. 2 is a diagram illustrating a robot operation system in a multi-cluster-based cloud environment according to an embodiment of the present disclosure;

FIG. 3 is a block diagram illustrating a multi-cluster service broker according to an embodiment of the present disclosure;

FIG. 4 is a diagram illustrating the structure of a container system based on an in-memory container storage according to an embodiment of the present disclosure;

FIG. 5 is a diagram illustrating an example of the structure of an in-memory container storage according to an embodiment of the present disclosure;

FIG. 6 is a diagram illustrating a scheme for generating an in-memory container storage according to an embodiment of the present disclosure;

FIG. 7 is a diagram illustrating the connection and configuration of a shared storage according to an embodiment of the present disclosure;

FIG. 8 is a diagram illustrating a hybrid form of a virtual machine and a container in a virtual machine-container integrated system according to an embodiment of the present disclosure;

FIG. 9 is an operation flowchart illustrating a robot operation method in a multi-cluster-based cloud environment according to an embodiment of the present disclosure; and

FIG. 10 is a diagram illustrating a computer system according to an embodiment of the present disclosure.

### DESCRIPTION OF THE PREFERRED EMBODIMENTS

The present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the present disclosure to those skilled in the art. Therefore, the shapes, sizes, etc. of elements in the drawings may be exaggerated for clear illustration.

In the entire specification, when a certain element is described as “comprising” or “including” a specific component, it means that, unless explicitly stated otherwise, the certain element may further include additional components without excluding the additional components.

The present disclosure may be variously modified and may have various embodiments, and the embodiments are intended to be illustrated and described in detail in the accompanying drawings.

However, this is not intended to limit the present disclosure to particular embodiments, and it should be appreciated that all changes, equivalents, and substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. Terms that are generally defined in commonly used dictionaries should be construed as having meanings consistent with their contextual usage in the relevant technical field, and, unless explicitly defined in this application, and should not be construed in an idealized or unduly formal sense.

It will be understood that when a component is referred to as being “associated” with another component, it can be directly associated with or connected to the other component, but other intervening components may be present therebetween.

The terms used in the present disclosure are used only to describe a specific embodiment, and are not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In the description of the present disclosure, independent reference numerals are used to designate the same components in the drawings to facilitate overall understanding.

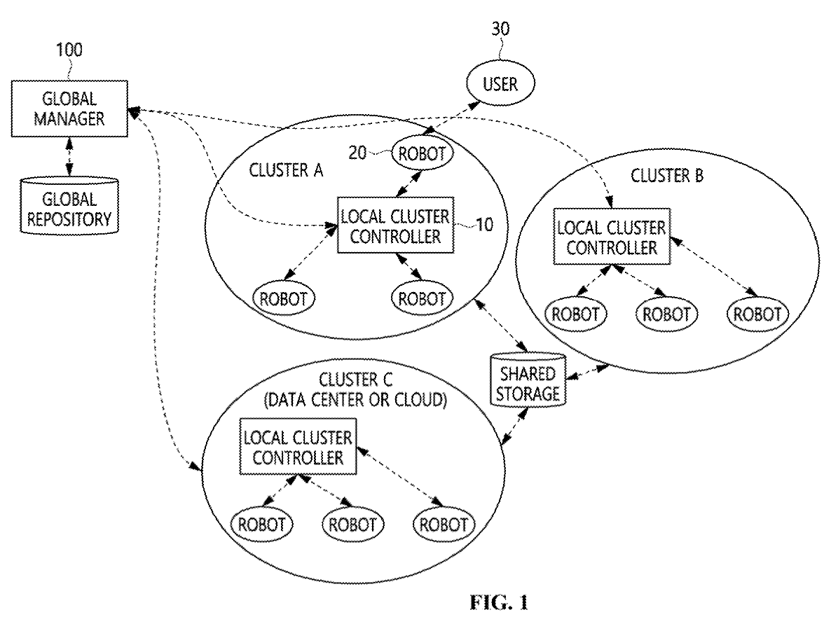

FIG. 1 is a diagram illustrating a system for operating cloud-based multi-cluster edge computing according to an embodiment of the present disclosure.

Referring to FIG. 1, it can be seen that each cluster includes a master node 10 and worker nodes 20, and that the worker nodes 20 correspond to robots. It can be seen that each worker node 20 is equipped with a basic computing system that structurally includes internal computing, storage, memory, and network components (e.g., a Raspberry Pi, an onboard system, or a small computer), and that one master controller 10 is present in each cluster (as a local cluster controller).

As a system that manages all clusters, a global manager 100 is present and is equipped with a global repository. Respective clusters may have different network domains. Each cluster has a Kubernetes environment, by which the cluster may be constructed and robot modules (i.e., modules related to Robot Operating System 2 (ROS2)) corresponding to respective robots may be deployed. A user 30 may access a robot system to manage the robots. Further, the manager of robots may access modules in the clusters and the global management system, and may then deploy robots to various clusters and manage the robots. In order to manage robots through the above-described system, the following basic operations may be performed.

Each cluster may be operated as an independent Kubernetes cluster. A cluster in each of a cloud and a data center may be operated in the form of a core cloud having larger resources (cluster C).

The robot system may operate as a worker node in each cluster, and may run an ROS2 node (Publisher/Subscriber).

Communication between ROS2 nodes (Data Distribution Service (DDS)-based communication) may be performed over a network between two clusters.

Because the Kubernetes and DDS basically assume communication within the same network, network connection between clusters may be required.

Because ROS2 exchanges messages between nodes based on DDS, network setup of the DDS may be adjusted so that ROS2 nodes in two clusters can communicate with each other. DDS may basically discover nodes using a multicast method. Therefore, a container network interface (CNI) plugin supporting multicast may be installed, otherwise the unicast method of the DDS may be activated.

ROS2 nodes between clusters may be discovered using the DNS function of Kubernetes. An ExternalDNS function may be used to synchronize the DNS names of the ROS2 service with an external DNS service. For example, the ROS2 node of cluster A may be set to ros2-a.example.com, and cluster B may discover the ROS2 node.

The core of the present disclosure is a method for operating robots across clusters, which requires that network connections between clusters be ensured. To achieve this, an IPsec tunneling technique between clusters may be employed to provide data security and allocate a dedicated network. Through this data network, the present disclosure may function to exchange messages between robots on different networks by sharing an in-memory-based storage via a Network File System (NFS). As a cloud-based system, each system may use both a virtual machine and a container, and may utilize high-performance computing devices (e.g., GPU, NPU, ASIC, hardware accelerator, etc.) deployed in each cluster.

To set up network connection between clusters A and B, IPsec tunneling may be used.

A multicast or unicast method may be appropriately configured to perform DDS communication of ROS2, and may establish an environmental variable such as ROS_DOMAIN_ID.

The ROS2 node between clusters may be stably discovered by utilizing the DNS and services of Kubernetes.

Stable and efficient ROS2 communication may be implemented in a multi-cluster environment based on optimized QoS settings and failure recovery strategies.

The network connection for communication, such as topic messages, between ROS2 nodes may operate according to the Data Distribution Service (DDS)-based communication mechanism of ROS2. The DDS may enable distributed communication between the ROS2 nodes, and may automatically set up connection on the network to exchange data between modules.

In ROS2, a subscriber and a publisher may exchange data through topics.

The publisher may publish data to a specific topic.

The subscriber may subscribe to the specific topic to receive the data published by the publisher.

With an automatic matching function, ROS2 may automatically discover and connect the subscriber and the publisher using DDS on the network.

The DDS may manage connection between the publisher and the subscriber, and network connection setup may be processed by DDS middleware.

A participant may be an entity allowing the ROS2 node to participate in the DDS network.

The DDS may conduct discovery of performing automatic discovery between nodes that use the same domain ID.

The Quality of Service (QoS) may control communication through settings such as message delivery assurance, reliability, and latency.

ROS2 may basically transmit data packets using a User Datagram Protocol (UDP), and may also support a Transmission Control Protocol (TCP) as needed. The design of DDS may be optimized to efficiently utilize network resources.

Each node may perform communication through a specific port among UDP ports, and may basically use a DDS protocol.

The multicast/broadcast method may be used at an initial node discovery step.

In order for ROS2 nodes to communicate with each other, they need to have the same domain ID. The domain ID may be used to logically distinguish node groups from each other in the network. When the same domain ID is set, communication is possible on different clusters. The reason for this is that settings are made to enable communication over networks constructed through IPsec tunneling between clusters.

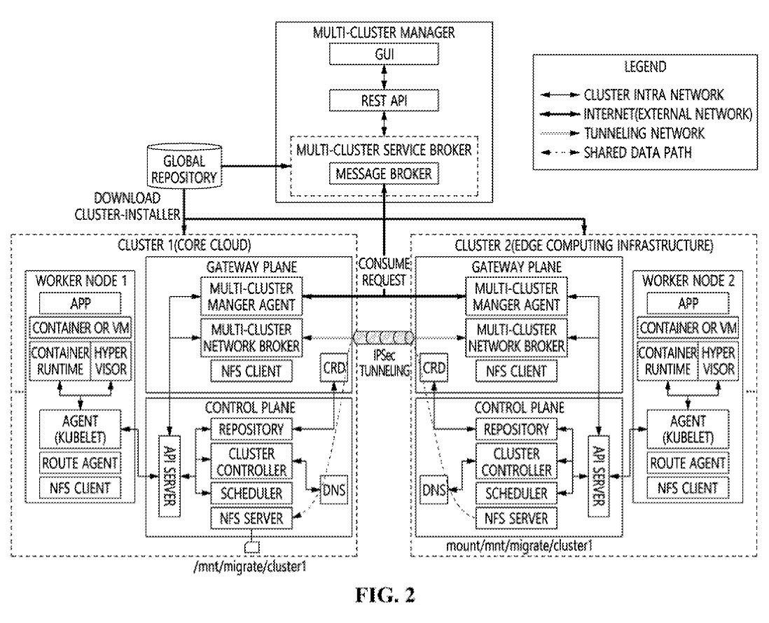

FIG. 2 is a diagram illustrating a robot operation system in a multi-cluster-based cloud environment according to an embodiment of the present disclosure.

Referring to FIG. 2, the robot operation system in a multi-cluster-based cloud environment according to an embodiment of the present disclosure may connect and manage systems between two clusters (K8S). An edge computing infrastructure may be composed of computer nodes, servers, compact devices, network devices with computing capabilities, clustered nodes, and the like. In FIG. 2, cluster 1 or cluster 2 may belong to a Kubernetes environment. In another example, cluster 1 or cluster 2 may also belong to a public or private cloud environment of a cloud computing environment. In FIG. 2, a control plane may be configured in infrastructures in both cloud and on-premises environments.

In a container-based platform (Kubernetes or the like), a virtual machine (VM) may be used by deploying a virtual machine-integrated agent. In a virtual machine-based platform (OpenStack or like), container workloads may be run and managed by installing a container-integrated agent.

A multi-cluster manager may include a GUI unit, a REST API server, and a multi-cluster service broker.

The multi-cluster service broker may perform core-edge and edge-edge interconnection functions.

Here, the multi-cluster service broker may be one of Kubernetes (K8S) clusters having Custom Resource Definition (CRD) required to store cluster information in a repository (e.g., K8s etcd) to interconnect multiple clusters to the network, and the multi-cluster manager in which the multi-cluster service broker is installed may perform a network connection function.

The GUI unit may provide a user interface for managing multiple clusters.

Each cluster may include a control plane (i.e., a control node), a gateway plane (i.e., gateway node), and a worker node.

The control plane may be configured in a base cluster (K8S) master node or in a single node.

The control plane may include a Domain Name System (DNS) server, an API server, a repository, a cluster controller, and a scheduler.

The DNS server may correspond to the DNS server of the cluster network.

The API server may provide cluster-related commands and multi-cluster connection functions.

The repository may correspond to a key-value type data repository (e.g., K8S etcd).

The cluster controller may provide a control function for cluster management (e.g., Kubeadm or the like).

The scheduler may correspond to a scheduler for cluster load balancing.

The gateway node may be configured within the control plane, and may be configured at any location inside the cluster.

The gateway node may include a multi-cluster manager agent, a multi-cluster network broker, and a Network File System (NFS) client.

The multi-cluster manager agent may execute an agent program that performs commands through the multi-cluster manager and the message broker.

The multi-cluster network broker may provide network connection between clusters and a gateway (e.g., Submariner).

The multi-cluster network broker may include a broker, a route agent unit, a service discovery unit, a gateway engine unit, and a global network unit.

The broker may include Custom Resource Definition (CRD), and may exchange metadata between gateway engines (mutual search).

The route agent unit (Route Agent) may perform cross-cluster traffic routing from the corresponding node to the gateway engine.

The service discovery unit (Service Discovery) may support DNS-based service search and service registration in the cluster.

The gateway engine unit (Gateway Engine) may manage a secure tunnel for network connection to other clusters (IPSec connection).

The global network unit (Global net) may handle interconnection between clusters having overlapping Classless Inter-Domain Routing (CIDR) ranges.

The worker node may include an agent unit, a route agent unit, an NFS client unit, and a container runtime unit.

The agent unit (Agent, e.g., Kubelet) may process commands for controlling the worker node from the cluster controller and manage the worker node.

The route agent unit (Route agent) may provide a router engine for connecting the inside of the cluster to the gateway.

The container runtime unit (Container Runtime) may provide an interface for running containers.

As illustrated in FIG. 2, two clusters cluster 1 and cluster 2 may be managed by the multi-cluster manager, and multiple clusters may be managed by the multi-cluster service broker within the multi-cluster manager. To manage this, the entire system may be managed and controlled through the multi-cluster manager agent of the gateway plane of the corresponding cluster.

A global repository may be used to connect one cluster to another cluster in the state in which only one cluster is configured to implement system connections. When a physical server enables Internet connection, an operating system (OS) is installed, and the multi-cluster manager is permitted to access the physical server in order to configure an initial edge computing infrastructure, the multi-cluster manager may access the edge computing infrastructure to download a cluster installer from the global repository (e.g., GitHub or Internet-based repository), and may perform initial provisioning. The initial provisioning may proceed in the following order.

The initial provisioning may be performed to install a runtime environment.

The initial provisioning may be performed to set up the control plane.

Here, the initial provisioning may be performed to set up each cluster and connect internal cluster networks.

The initial provisioning may be performed to install the multi-cluster network broker (e.g., Submariner.io).

The initial provisioning may be performed to install and set up the Network File System (NFS) server.

Here, the initial provisioning may be performed to install and mount the server and client of the cluster node.

The initial provisioning may be performed to install the multi-cluster manager agent.

In the initial provisioning, cluster setup and network connection may not be performed in the case of a single node.

When the initial provisioning is completed, the multi-cluster service broker may connect networks between clusters through the routine such as that illustrated in the following FIG. 2.

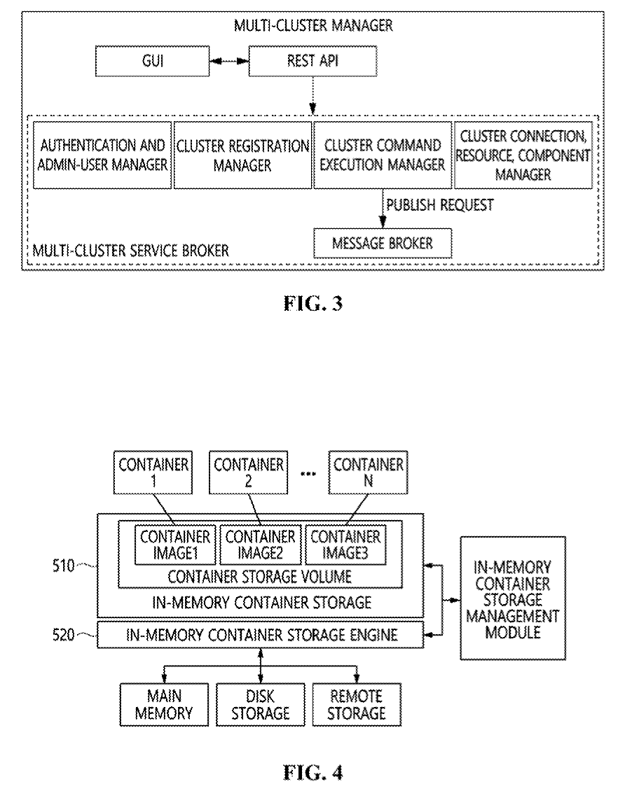

FIG. 3 is a block diagram illustrating a multi-cluster service broker according to an embodiment of the present disclosure.

Referring to FIG. 3, the multi-cluster service broker of the multi-cluster manager may include an authentication and user manager (or an authentication and administration (admin)-user manager), a cluster registration manager, a cluster command execution manager, and a cluster resource manager (or a cluster connection, resource, and component manager).

The authentication and user manager (authentication and admin-user manager) may perform registration and management of automation policies and operations to perform user registration in the system and system administration.

The cluster registration manager may receive a cluster name and a cluster description through a user web and perform registration of a new cluster.

The cluster command execution manager, which is a module that processes cluster command execution requests, may perform functions such as cluster resource control (e.g., execution or deletion of resource manifests), multi-cluster network control (e.g., deployment, joining to local or remote brokers, exporting and unexporting of cluster services), shared storage control (e.g., creation of repository in a local cluster or connection to a repository in another cluster), and control of multi-cluster network performance measurement.

The cluster resource manager may periodically monitor resource change events, the performance index of nodes constituting a cluster (CPU, memory, network), and the latency of a multi-cluster network.

When a shared storage (or shared repository) between clusters is configured, it is favorable to configure a high-speed repository. Of course, because the system is based on an NFS, the cluster performance is primarily dependent on network performance, but the use of a repository with higher read and write speeds basically provides assistance in network performance. The present disclosure may configure and use a shared storage (or shared repository) mounted in the NFS by configuring a Solid State Drive (SSD), NVMe, a Compute Express Link (CXL)-based Dynamic Random Access Memory (DRAM) module, Processing-in-Memory (PIM), or the like as the storage. The memory of the current server system is volatile memory such as DRAM, and the repository may be configured by applying DRAM to a tmpfs file system, but the present disclosure may propose and use additional memory using DRAM together with the memory.

FIG. 4 is a diagram illustrating the structure of a container system based on in-memory container storage according to an embodiment of the present disclosure.

Referring to FIG. 4, the container system based on the in-memory container storage according to the present disclosure may include in-memory container storage 510, an in-memory container storage engine 520, main memory, disk storage, and a remote storage.

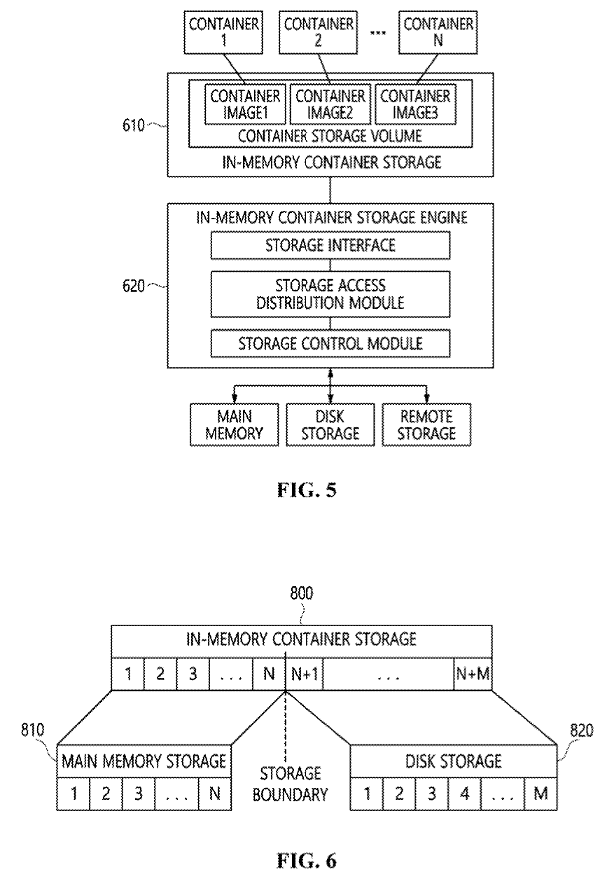

FIG. 5 is a diagram illustrating an example of the structure of in-memory container storage according to an embodiment of the present disclosure.

Hereinafter, the structure and operation flow of the in-memory container storage according to the present disclosure will be described in detail with reference to FIG. 5.

First, a container may generate in-memory container storage 610, which is storage in main memory having nonvolatile characteristics, and may configure a storage volume for the container in the in-memory container storage 610.

The container may generate and operate a container storage volume, which is the volume of a file system (example of a docker is /var/lib/docker) in which the container runs in the in-memory container storage 610. Therefore, a container access command generated by the container may be transferred to the in-memory container storage 610.

An in-memory container storage engine 620 may generate single shape in-memory container storage 610 by unifying the main memory, disk storage, and remote storage. Also, the in-memory container storage engine 620 may process a disk access command by utilizing the main memory, the disk storage, and the remote storage in an integrated manner.

In this case, the in-memory container storage 610 may be operated, without separate modification, by providing a standard block storage-format interface through the in-memory container storage engine 620.

FIG. 6 is a diagram illustrating a scheme for generating in-memory container storage according to an embodiment of the present disclosure.

Referring to FIG. 6, a method for generating single hybrid-type in-memory container storage 800 by unifying main memory storage 810 with disk storage 820 is illustrated.

The in-memory container storage 800 may provide a standard block storage format, and may be generated by mapping the area of the main memory storage 810 to the head portion of the storage and mapping the area of the disk storage 820 to the tail portion of the storage.

For example, the area corresponding to block IDs 1 to N of the main memory storage 810 may be mapped to the area corresponding to block IDs 1 to N of the in-memory container storage 800. Further, the area corresponding to block IDs 1 to M of the disk storage 820 may be mapped to the area corresponding to block IDs N+1 to N+M of the in-memory container storage 800. Here, a storage boundary for distinguishing the area of the main memory storage 810 from the area of the disk storage 820 may be set between the block IDs N and N+1 of the in-memory container storage 800.

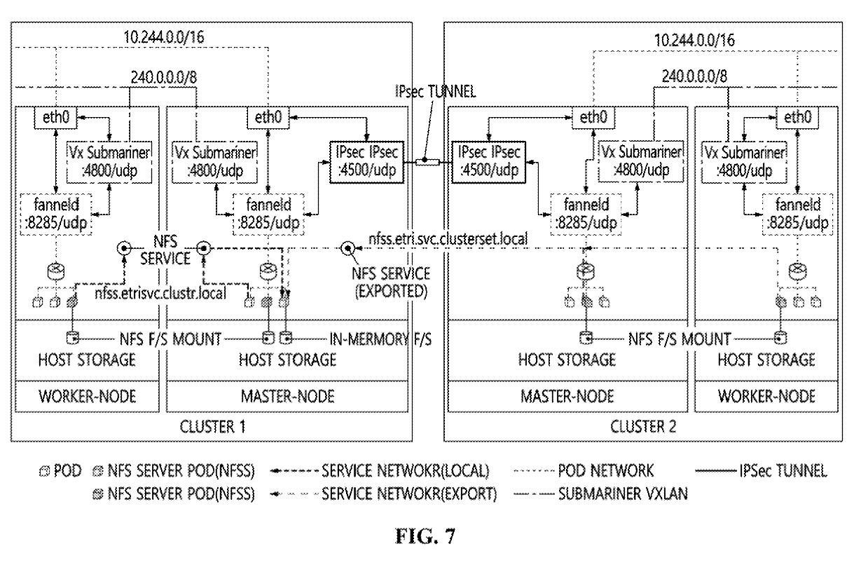

FIG. 7 is a diagram illustrating the connection and configuration of a shared storage according to an embodiment of the present disclosure.

Referring to FIG. 7, the design of an NFS-based multi-cluster shared storage of an in-memory file system is illustrated. First, cluster 1 (cluster name: north-cls) and cluster 2 (cluster name: south-cls) are interconnected through Internet Protocol Security (IPsec) tunnel-based pod networks of Submariner. Cluster 1 deploys an NFS server pod (deployment name: nfs-server-north-cls, namespace: edge) and a service (service name: nfs-server-north-cls, namespace: edge, service type: ClusterIP) to a local cluster.

Here, the NFS server pod (i.e., nfss pod) may function as a high-speed repository in a multi-cluster environment by setting an in-memory file system directory configured by a host (i.e., master node of the north cluster) as an NFS service directory.

When cluster 1 deploys the NFS client (pod name: nfs-client-north-cls, namespace: edge) to all nodes, the NFS client pod may access the NFS server via the domain address “nfs-server-north-cls.edge.svc.cluster.local” through the DNS of the cluster. All NFS client pods may be connected to the NFS server to mount (F/S type: nfs) a shared directory (“/mnt/nfs-vol/north-cls”) as the file system of their own local nodes, and thus all NORTH cluster nodes may share the file system through the “/mnt/shared/north-cls” directory.

Next, cluster 1 allows cluster 2 to access the service of the NFS server using the service export function of the multi-cluster network broker. When the export of the nfss service of the cluster 1 has succeeded, the service discovery unit of multi-cluster network broker operating in cluster 2 adds nfss service access domain of cluster 1, which is exported, to the DNS of cluster 2. All pods and services of cluster 2 may access the NFS server of cluster 1 via the address “nfs-server-north-cls.edge.svc.clusterset.local”.

Next, cluster 2 may deploy the NFS client (NFS server address: nfs-server-north-cls.edge.svc.clusterset.local, mount directory: /mnt/nfs-vol/north-cls, F/S type:nfs) to all nodes, thus allowing all nodes in cluster 2 to share the file system with cluster 1 through the directory “/mnt/shared/north-cls” of a host.

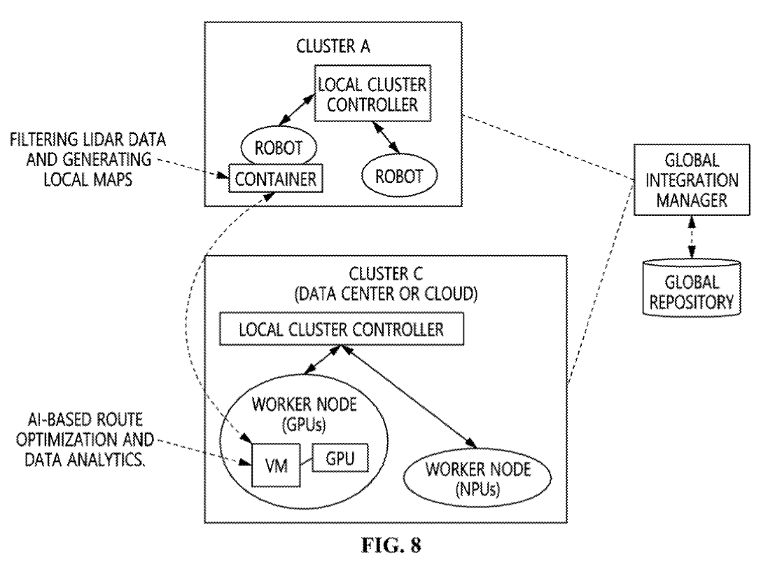

FIG. 8 is a diagram illustrating a hybrid form of a virtual machine and a container in a virtual machine-container integrated system according to an embodiment of the present disclosure.

Referring to FIG. 8, a configuration may be shown in which the virtual machine and the container are used in a hybrid form across different machines in the virtual machine-container integrated system. In a robot system, container modules mounted on robots may interoperate with a virtual machine in a data center or a public cloud environment functioning as the core cloud.

Each container may be deployed in a local cluster (edge cloud) close to a robot to process real-time tasks. The container may perform real-time tasks (e.g., obstacle avoidance or local map generation) of the robot due to the fast startup time and lightweight resource usage. Also, through Kubernetes, the container may be dynamically extended or may be quickly recovered in the event of a failure. In this way, latency may be minimized in tasks requiring real-time responsiveness, and lightweight modules may be rapidly deployed and managed. Meanwhile, when the clustered core cloud is deployed and operated using virtual machines (VMs), complex and resource-intensive tasks (e.g., global path planning, high-resolution map generation, and AI model inference) are processed. Each virtual machine (VM) may perform stable tasks in an environment in which task isolation and security are important, may use acceleration devices such as a GPU and an NPU, which are high-performance computing devices of the data center and the cloud, and may perform a task of training robots and generating models by processing long-distance tasks or processing pieces of robotic data of multiple robots in an integrated manner. When the system is utilized in this way, performance optimization may be enabled in a complicated computing task, and a stable and reliable environment may be provided without interference between tasks.

Use cases for hybrid virtualization model for the distributed cloud may be described as follows.

The hybrid virtualization model is a model in which the container and the virtual machine (VM) are combined to execute applications on different physical machines.

The hybrid virtualization model may be applied to applications that need to support the operation of a distributed system (e.g., distributed cloud or edge computing) in various infrastructures including a non-virtualized environment (i.e., infrastructure without virtualization) or physical machine clustering (clustering of physical machines).

Also, the hybrid virtualization model may provide a more flexible structure in which infrastructure components can be mixed regardless of whether the container and the virtual machine are present. In the hybrid virtualization model, some applications may run in the form of a container, and other applications may run on virtual machines or non-virtualized physical machines. This structure is especially useful for a cloud service provider (CSP) that needs to accommodate non-virtualized legacy applications.

FIG. 8 illustrates an example of the configuration of a VM-container integrated system in which a virtual machine and a container operate in a hybrid form. In the robot system, it can be seen that a container module mounted on a robot is mutually connected to a virtual machine located in a data center or a public cloud environment (core cloud), thus configuring an integrated hybrid cloud environment.

As illustrated in FIG. 8, in a local cluster (edge cloud), a container may be deployed near the robot to process real-time tasks. The container is suitable for real-time tasks of the robot (e.g., obstacle avoidance or local map generation) due to the characteristics of fast startup time and lightweight resource usage.

Furthermore, because the container may be dynamically extended or quickly recovered in the event of a failure through the cluster, latency may be minimized and fast deployment and management of a lightweight module may be provided in tasks requiring real-time responsiveness.

On the other hand, in the core cloud, a virtual machine (VM) may be deployed in the form of a cluster, thus processing complex and resource-intensive tasks (e.g., global path planning, high-resolution map generation, or AI model inference).

The virtual machine may perform stable operation in an environment in which task isolation and security are important, and may perform complicated computing tasks such as integrated data processing, long-distance computing, and model training and generation by multiple robots by utilizing high-performance computing devices such as GPU or NPU.

By means of this structure, performance optimization of complicated computing tasks may be achieved, and stable and reliable environments without interference between tasks (operations) may be provided.

Virtual machine (VM)-container integration management may correspond to recommendations, and may support remote communication between the container and the virtual machine so as to perform interconnections among an edge cloud, a regional cloud, and a core cloud.

The VM-container integration management may provide a common API that simultaneously runs the virtual machine and the container at different locations.

Such VM-container integration management may provide a global storage function and a global integration management function so as to support the distributed cloud.

An example of deployment of robot modules in the distributed cloud is described as follows.

Each cluster in the distributed cloud is composed of a master node and worker nodes, wherein the worker nodes may correspond to robots.

Each worker node is equipped with a basic computing system (e.g., an onboard system or a small computer) including a CPU, a storage, memory, a network, and the like. In each cluster, a single local cluster controller may be present, and may function as a master controller of the corresponding cluster.

Further, in the cluster, there is a global integration manager that manages all clusters and includes a global repository. Respective clusters may have different network domains, and may deploy robot modules in a cloud native environment.

A Cloud Service Controller (CSC) may access the robot system to manage the robots.

Further, the robot manager may access the module of each cluster and the global management system to deploy and manage robots to multiple clusters.

In order for the system to operate the robots, the following basic tasks need to be performed.

A basic task item indicates that each cluster may function as an independent cluster.

(However, clusters in the cloud and data center may function as core clouds equipped with larger resources as in the case of cluster C)

The robot system may function as a worker node in each cluster, and each robot module may be executed in the structure of publisher/subscriber.

Communication between robot modules may be performed over the network between two clusters.

Communication between the cluster and the robot assumes communication in the same network, and network connection setup is required for communication between clusters.

The robot operation system operates based on a robot communication protocol for exchanging messages between nodes, and thus network setup may be adjusted to enable communication between robot modules of both clusters.

Basically, the robot communication protocol may be designed to use a multicast method to perform message delivery.

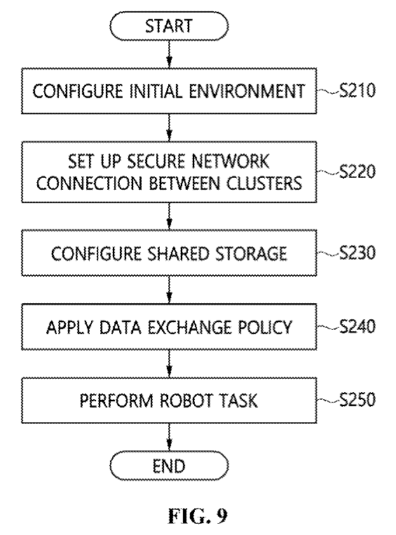

FIG. 9 is an operation flowchart illustrating a robot operation method in a multi-cluster-based cloud environment according to an embodiment of the present disclosure.

Referring to FIG. 9, the robot operation method in the multi-cluster-based cloud environment according to the embodiment of the present disclosure may first configure an initial environment at step S210.

That is, at step S210, the initial environment of the system may be configured.

Here, at step S210, node registration of each cluster, initialization of a Kubernetes environment, network domain setup, ROS2 middleware setup, and authentication configuration of a global manager may be performed.

Here, at step S210, a security certificate and a token for communication between the local controller of each cluster (local cluster controller) and a global integration manager may be set up, and a basic environment for communication, such as the node recognition of the robot and ROS_DOMAIN_ID setup, may be prepared.

Further, the robot operation method in the multi-cluster-based cloud environment according to the embodiment of the present disclosure may set up secure network connection between clusters at step S220.

That is, at step S220, the secure network connection between clusters may be set up using an IPsec tunnel.

Here, at step S220, a secure network may be formed through IPsec tunneling among cluster A, cluster B, and cluster C.

Communication data between individual clusters may be encrypted and transmitted over the secure network, and communication between nodes based on the Data Distribution Service (DDS) of ROS2 may be reliably performed across network boundaries.

In this case, at step S220, multicast or unicast DDS setup may be adjusted, and a module that supports multicast in a Container Network Interface (CNI) plugin may be installed or, alternatively, the DDS unicast mode may be activated.

Here, at step S220, the service name of ROS2 nodes may be synchronized with an external DNS service by utilizing the ExternalDNS and the service function of Kubernetes. For example, the nodes of other clusters may be discovered using the DNS name such as ros2-a.example.com.

Further, the robot operation method in the multi-cluster-based cloud environment according to the embodiment of the present disclosure may construct a shared storage at step S230.

That is, at step S230, a data synchronization policy between robots may be established by configuring an in-memory-based shared storage.

In order to maintain data consistency between clusters and enable a collaborative task between robots, an in-memory-based Network File System (NFS) may be configured.

The shared storage may connect the local storage of each cluster to the global repository, thus enabling sharing and backup of real-time task data (map, log, training data, etc.) of the robot.

Furthermore, the shared storage may include interconnection between the memory cache and block storage to support high-speed data input/output, and storage access priority may be set depending on the QoS policy.

In this case, at step S230, the in-memory-based shared storage may be configured by connecting the global repository to the local repositories of the multiple clusters.

Here, at step S230, storage access priority for the in-memory-based shared storage may be set depending on a preset QoS policy.

Here, at step S230, data that is generated during real-time processing of robot tasks may be first stored in the local repository, and data required for collaboration between clusters may be set to be synchronized with the global repository.

Furthermore, the robot operation method in the multi-cluster-based cloud environment according to the embodiment of the present disclosure may apply a data exchange policy at step S240.

That is, at step S240, the data exchange policy between robots may be established based on a preset framework.

Here, at step S240, each robot may transmit data through topics based on the publisher/subscriber structure of a Robot Operating System 2 (ROS2) framework.

Here, at step S240, each robot node may publish and subscribe to messages on a topic basis, based on the publisher/subscriber structure of ROS2.

The publisher may publish local sensor data, robot state information, and map update data, and the subscriber may subscribe to them, and may then interoperate with the AI module of another robot or a core cloud.

Also, the global manager may manage the data exchange policy of each cluster, and may apply policies such as message reliability, latency, and data loss assurance, based on Quality of Service (QoS) parameters.

On the network, automatic discovery of the ROS2 node may be performed by DDS middleware, and automatic connection may be established between nodes having the same domain ID.

Here, at step S240, a failure recovery strategy (failover policy) and a load balancing policy may be dynamically applied, and thus task efficiency between clusters may be optimized.

Furthermore, the robot operation method in the multi-cluster-based cloud environment according to the embodiment of the present disclosure may perform a robot task at step S250.

That is, at step S250, the robot task may be performed through a container and a virtual machine that are deployed in clusters.

Here, at step S250, a common API that simultaneously runs the virtual machine and the container may be provided.

Here, at step S250, the container deployed in the edge cloud (local cluster) may perform real-time tasks of the robot (e.g., action task, obstacle avoidance, local map generation, and sensor fusion).

Based on fast startup time and low resource usage, the container may process tasks requiring real-time responsiveness and may be automatically recovered in the event of a failure.

Here, at step S250, the virtual machine deployed in a core cloud (cluster of the data center) may perform complicated computing tasks (e.g., global path planning, high-resolution map generation, or AI model inference) requiring high-performance computing.

In this case, the virtual machine may process pieces of data from multiple robots in an integrated manner by utilizing hardware accelerators such as a GPU or a NPU, and may stably process high-load tasks such as long-distance path planning or training model generation.

A robot manager may deploy and control robots between clusters through a Cloud Service Controller (CSC), and may manage communication efficiency based on the QoS policy.

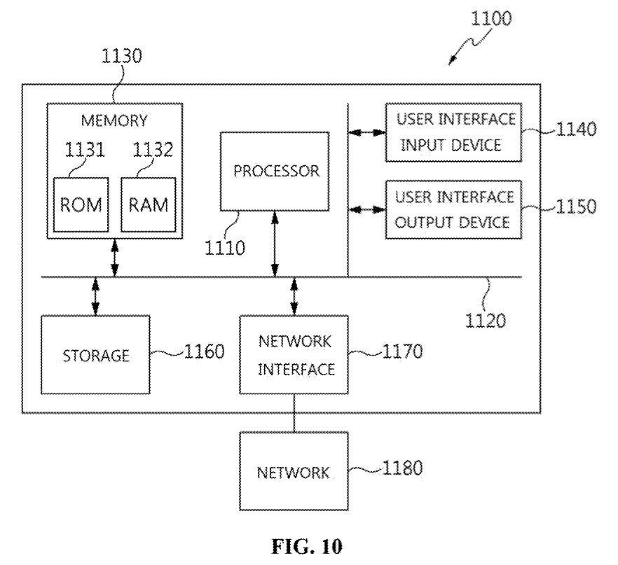

FIG. 10 is a diagram illustrating a computer system according to an embodiment of the present disclosure.

Referring to FIG. 10, a robot operation apparatus in a multi-cluster-based cloud environment according to an embodiment of the present disclosure may be implemented in a computer system 1100 such as a computer-readable storage medium. As illustrated in FIG. 10, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

Further, a robot operation apparatus in a multi-cluster-based cloud environment according to an embodiment of the present disclosure may include one or more processors 1110 and memory 1130 configured to store at least one program that is executed by the one or more processors 1110, wherein the at least one program is configured to set up a secure network connection between clusters using an Internet Protocol Security (IPsec) tunnel, establish a data synchronization policy between robots by configuring an in-memory-based shared storage, establish a data exchange policy between robots based on a preset framework, and perform a robot task through a container and a virtual machine that are deployed in the clusters.

Here, the at least one program may be configured to construct the in-memory-based shared storage by connecting a global repository to local repositories of multiple clusters.

Here, the at least one program may be configured to set storage access priority for the in-memory-based shared storage based on a predefined QoS policy.

Here, the at least one program may be configured to preferentially store data generated during real-time processing of the robot task in the local repository, and set data required for collaboration between the clusters to be synchronized with the global repository.

Here, the at least one program may be configured such that each robot transmits data through a topic based on a publisher/subscriber structure of a preset Robot Operating System 2 (ROS2) framework.

Here, the at least one program may be configured to provide a common Application Programming Interface (API) configured to simultaneously run the virtual machine and the container.

Here, the at least one program may be configured such that a container deployed in a local cluster, among the clusters, performs an action task of the robot.

Here, the at least one program may be configured such that a virtual machine deployed in a cluster of a data center, among the clusters, performs a computing task of the robot.

The present disclosure may provide a method for managing a modularized robot in single-cluster and multi-cluster environments.

Further, the present disclosure may ensure the operation of a high-performance robot module by utilizing resources integrated with virtual machines in a container environment of existing Kubernetes (K8S).

Furthermore, the present disclosure may generate a high-speed storage for efficient data exchange between clusters.

Furthermore, the present disclosure may improve the speed of a shared storage through high-speed network connection between clusters.

Furthermore, the present disclosure may solve memory constraints and ensure easy use with an integrated kernel.

Furthermore, the present disclosure may construct a high-speed network that enables the connection of a multi-cluster network to be performed at high speed.

Furthermore, the present disclosure may share various types of application data between clusters, without transmitting the data, through a shared storage function based on a high-performance computing environment.

Furthermore, the present disclosure may provide a system usable when access to different domains is impossible through an existing DDS, and ensure real-time performance, data persistence, etc. through a high-speed memory-based shared storage.

As described above, in the robot operation apparatus in a multi-cluster-based cloud environment according to embodiments of the present disclosure, the configurations and schemes in the above-described embodiments are not limitedly applied, and some or all of the above embodiments can be selectively combined and configured such that various modifications are possible.

What is claimed is:

1. A robot operation apparatus in a multi-cluster-based cloud environment, comprising:
one or more processors; and
a memory configured to store at least one program that is executed by the one or more processors,
wherein the at least one program is configured to:
set up a secure network connection between clusters using an Internet Protocol Security (IPsec) tunnel,
establish a data synchronization policy between robots by configuring an in-memory-based shared storage,
establish a data exchange policy between robots based on a preset framework, and
perform a robot task through a container and a virtual machine that are deployed in the clusters.

2. The robot operation apparatus of claim 1, wherein the at least one program is configured to construct the in-memory-based shared storage by connecting a global repository to local repositories of multiple clusters.

3. The robot operation apparatus of claim 2, wherein the at least one program is configured to set storage access priority for the in-memory-based shared storage based on a predefined QoS policy.

4. The robot operation apparatus of claim 2, wherein the at least one program is configured to preferentially store data generated during real-time processing of the robot task in the local repository, and set data required for collaboration between the clusters to be synchronized with the global repository.

5. The robot operation apparatus of claim 1, wherein the at least one program is configured such that each robot transmits data through a topic based on a publisher/subscriber structure of a preset Robot Operating System 2 (ROS2) framework.

6. The robot operation apparatus of claim 1, wherein the at least one program is configured to provide a common Application Programming Interface (API) configured to simultaneously run the virtual machine and the container.

7. The robot operation apparatus of claim 1, wherein the at least one program is configured such that a container deployed in a local cluster, among the clusters, performs an action task of the robot.

8. The robot operation apparatus of claim 1, wherein the at least one program is configured such that a virtual machine deployed in a cluster of a data center, among the clusters, performs a computing task of the robot.

9. A robot operation method in a multi-cluster-based cloud environment, performed by a robot operation apparatus in a multi-cluster-based cloud environment, the robot operation method comprising:
setting up a secure network connection between clusters using an Internet Protocol Security (IPsec) tunnel;
establishing a data synchronization policy between robots by configuring an in-memory-based shared storage;
establishing a data exchange policy between robots based on a preset framework; and
performing a robot task through a container and a virtual machine that are deployed in the clusters.

10. The robot operation method of claim 9, wherein establishing the data synchronization policy comprises:
constructing the in-memory-based shared storage by connecting a global repository to local repositories of multiple clusters.

11. The robot operation method of claim 10, wherein establishing the data synchronization policy further comprises:
setting storage access priority for the in-memory-based shared storage based on a predefined QoS policy.

12. The robot operation method of claim 10, wherein establishing the data synchronization policy further comprises:
preferentially storing data generated during real-time processing of the robot task in the local repository, and setting data required for collaboration between the clusters to be synchronized with the global repository.

13. The robot operation method of claim 9, wherein establishing the data exchange policy comprises:
allowing each robot to transmit data through a topic based on a publisher/subscriber structure of a preset Robot Operating System 2 (ROS2) framework.

14. The robot operation method of claim 9, wherein performing the robot task comprises:
providing a common Application Programming Interface (API) configured to simultaneously run the virtual machine and the container.

15. The robot operation method of claim 9, wherein performing the robot task comprises:
allowing a container deployed in a local cluster, among the clusters, to perform an action task of the robot.

16. The robot operation method of claim 9, wherein performing the robot task comprises:
allowing a virtual machine deployed in a cluster of a data center, among the clusters, to perform a computing task of the robot.
